(19) United States
(12) Patent Application Publication
(10) Pub. No.: US 2011/0084868 A1
(43) Pub. Date: Apr. 14, 2011

(54) VARIABLE RANGE MILLIMETER WAVE METHOD AND SYSTEM

(75) Inventors: ROBERT PATRICK DALY, ORLANDO, FL (US); FARRELL Anthony SMALL, SANFORD, FL (US); JONATHAN Jensen Drewes, ORLANDO, FL (US)

(73) Assignee: BRIJOT IMAGING SYSTEMS, INC., LAKE MARY, FL (US)

(21) Appl. No.: 12/575,604

(22) Filed: Oct. 8, 2009

(51) Int. Cl. G01S 13/88; G01S 13/00; G01S 13/08

(52) U.S. Cl. 342/22; 342/54; 342/118; 342/176

(57) ABSTRACT

A variable range millimeter wave method and system is disclosed. In a particular embodiment, the system includes a primary mirror having an aperture to reflect millimeter wave energy to a secondary mirror, where the secondary mirror is disposed in front of the primary mirror and adapted to redirect the millimeter wave energy to a millimeter wave sensor/detector of a millimeter wave camera. The millimeter wave camera is configured to process the millimeter wave energy to visually detect concealed objects hidden on a target and an operating frequency of the millimeter wave camera is between 225 GHz and 275 GHz. In addition, the system includes a laser rangefinder, GPS and altimeter to determine a location of the target and to optimize a focus of the millimeter wave camera. A video monitor displays millimeter wave imagery and video images spatially and temporally relative to the millimeter wave imagery to aid targeting.

### I. FIELD

The present invention relates in general to the field of concealed object detection systems using millimeter wave imagery, and in particular to a variable range millimeter wave method and system.

### II. DESCRIPTION OF RELATED ART

A passive millimeter wave camera has the ability to detect and image objects hidden under clothing using millimeter wave imagery. The passive millimeter wave camera detects radiation that is given off by all objects. The technology works by contrasting the millimeter wave signature of the human body, which is warm and reflective, against that of a gun, knife or other contraband. Those objects appear darker or lighter because of the differences in temperature, hence, millimeter wave energy, between the human body and the inanimate objects.

An object-based scene is generated for viewing on a video monitor with individual objects having spatial and temporal relationships. The objects may be created in any number of ways, including signals from a passive millimeter wave camera and/or signals from a visible spectrum video camera.

However, no adequate method or system has been provided that reduces the probability of incorrect composite image analysis caused by a target too far or close to from the millimeter wave or visible spectrum cameras. Accordingly, there is a need in the relevant art for a variable range millimeter wave method and system to improve the focus of the millimeter wave imagery.

Over the last several years indoor millimeter wave (“MMW”) concealed object detection systems have provided reliable checkpoint security in a variety of public and private applications. However long distance and outdoor MMW deployments have been problematic. Long distance MMW optics in current operating ranges (generally below 100 GHz) is challenging. The relatively large wavelength of MMW at these frequencies causes the size of the optics to grow to unworkable size when trying to achieve reasonable resolution at a long standoff distance. Atmospheric attenuation can degrade detector performance at certain frequencies. Outdoor conditions of glint, glare, solar loading of emissive objects and the absolute cold temperature of the open sky in the MMW frequency band hamper and complicate existing imaging systems. The transmission properties of clothing can also change at different frequencies.

Accordingly, there is a need in the art for a variable range millimeter wave method and system for concealed weapon detection at large distances as a first line of defense for perimeter, facility and checkpoint threats.

There is also a need in the art for a variable range millimeter wave method and system that eliminates the need for ancillary equipment such as pressure-sensitive floor mats, light beams, ultrasonic motion detectors or the like to enable or disable image analysis, and hence the concealed object detection process.

Another need exists in the art for a variable range millimeter wave method and system that reduces the probability of incorrect image analysis caused by the target moving in an unexpected fashion in front of the cameras.

There is also a need in the art for variable range millimeter wave method and system that provides the ability to perform object triangulation on images produced from dissimilar imagers such as visible spectrum color cameras and millimeter wave cameras.

Another need exists in the art for a variable range millimeter wave method and system that improves the reliability of image analysis by performing multiple analyses on the same scene as viewed by different imagers and/or different camera locations/angles.

However, in view of the prior art at the time the present invention was made, it was not obvious to those of ordinary skill in the pertinent art how the identified needs could be fulfilled.

### III. SUMMARY

In a particular embodiment, a variable range millimeter wave method and system is disclosed. The system includes a primary mirror having an aperture to reflect millimeter wave energy to a secondary mirror, where the secondary mirror is disposed in front of the primary mirror and adapted to redirect the millimeter wave energy to a millimeter wave sensor/detector of a millimeter wave camera. The millimeter wave camera is configured to process the millimeter wave energy to visually detect concealed objects hidden on a target and the operating frequency of the millimeter wave camera is between 225 GHz and 275 GHz. In addition, the system includes a laser rangefinder to determine a distance to the target and to optimize focus of the millimeter wave camera. A video monitor displays millimeter wave imagery generated from the millimeter wave energy and video images spatially and temporally relative to the millimeter wave imagery to aid targeting.

The method includes identifying a target, determining a distance to the target, focusing a millimeter wave camera on the target, scanning millimeter wave energy of the target, processing the millimeter wave energy to generate millimeter wave imagery of the target, and displaying a video image and the millimeter wave imagery of the target on a video monitor. In addition, the method includes isolating the millimeter wave energy of the target from other persons and objects in a scene and detecting a concealed object on the target. An operating frequency of the millimeter wave camera is between 225 GHz and 275 GHz and is effective between distances of at least 30 m to 75 m. The resolution of the millimeter wave image is between 4.1² cm² and 13.0² cm². An optical diameter of the primary mirror may be approximately 1.0 m.

In another particular embodiment, a system includes computer hardware, software and external devices such as frame buffers, millimeter wave sensor controllers, hard disk drives and the like. The system performs triangulation on images produced from the dissimilar sources such as visible spectrum color cameras, visible grayscale cameras, millimeter wave cameras, infrared cameras, etc., to generate automatically focused composite images. Also, a means is provided to evaluate the imagery in the computer memory and determine the presence/absence of a person (target).

One particular advantage provided by the embodiments of the variable range millimeter wave method and system is that long distance detection offers a new first line of defense to perimeter threats for the multitude of outdoor applications encountered by military, security and law enforcement personnel on a daily basis. A variable long-range threat detection system detects concealed threats that are still outside of the perimeter of the controlled area, providing life saving time and distance to react to and resolve a possible threat.

A variable range millimeter wave method and system fills a critical need to secure checkpoints, border crossings, compounds, large public gatherings, sporting events, visits of dignitaries and similar permanent or temporary indoor or outdoor situations. The system is also a valuable tool and resource to law enforcement for securing public areas, establishing probable cause for questioning, search and detention, securing crime scenes and riot scenes, as well as in response to credible intelligence of a threat to an unprotected or even secured location. The definitive, objective results of concealed object screening eliminate legal concerns raised by profiling and random sampling.

Another particular advantage provided by the embodiments of the variable range millimeter wave method and system is the ability to evaluate images from multiple sources in real time in order to better authenticate the presence of objects-of-interest in the images. Motion is detected in the scene by comparing multiple successive images so that the detection process is enabled or disabled based on the comparison results. In addition, an evaluation of multiple successive images can determine and calculate the relative motion of any objects-of-interest including direction, velocity and classification of motion (e.g., stationary, moving, rotating in place). The imagery of the visible spectrum camera and the millimeter wave camera convert the imagery into digital form and store the imagery in a computer memory device.

Another particular advantage provided by the embodiments of the variable range millimeter wave method and system is the ability to calculate the location and size of objects-of-interest in video images in real time and then automatically base further detection methodology according to the results. In addition, image processing can be altered based on the calculated results including early termination of further analysis, more detailed further analysis, or the use of different analysis methodology including differing inspection criteria, programs, algorithms, settings and sensitivities.

Another particular advantage provided by the embodiments of the variable range millimeter wave method and system is the ability to provide a means to selectively, automatically and intelligently indicate to subsequent computer software and algorithms the findings of the target's distance, direction and relative motion so that the subsequent computer software and algorithms can adaptively use differing inspection criteria, programs, algorithms, settings and sensitivities when evaluating the image (e.g., for threat detection, weapons detection, or detection of other objects).

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a perspective view of a particular embodiment of variable range millimeter wave method;

FIG. 2 is an elevational view of the particular illustrative embodiment of the variable range millimeter wave system of FIG. 1;

FIG. 3 is a front view of Cassegrain style optics of the variable range millimeter wave system of FIGS. 1 and 2;

FIG. 4 is a ray trace of the Cassegrain style optics for one embodiment of the variable range millimeter wave system;

FIG. 5 is a schematic diagram of a deployment of the variable range millimeter wave system;

FIG. 6 is a table of the variable range millimeter wave system object resolution at various distances; and

FIG. 7 is a flow diagram of a particular embodiment of a variable range millimeter wave method.

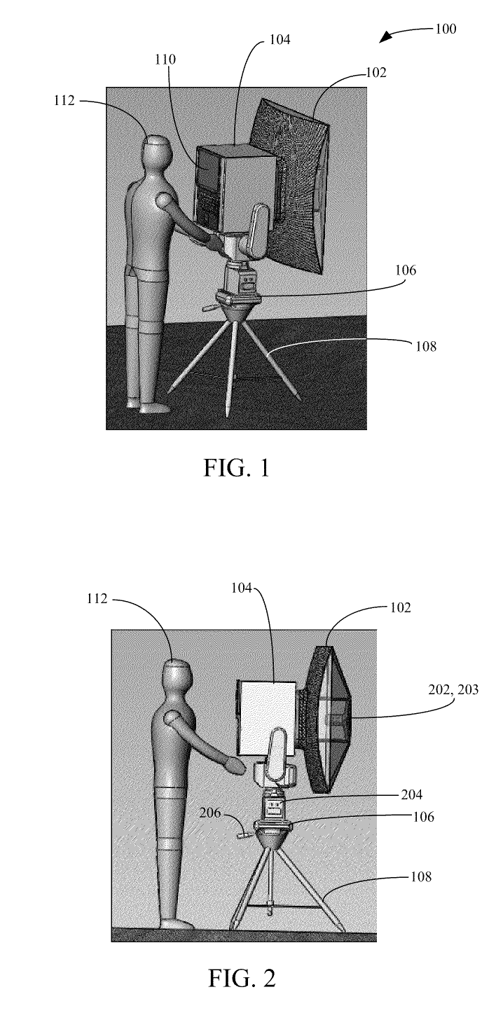

### V. DETAILED DESCRIPTION

The variable range millimeter wave system may be transported by car, truck, tactical vehicle, or by aircraft. The system can be unloaded by hand, lift-truck, or ramp and moved into position on a site consisting of packed earth or sand, heavy gravel, concrete, etc. The system may be used indoors within any large building, air terminal, or lobby. In addition, the system may also be located outdoors under an open-sided shed, tent, or canopy to provide shelter from the elements for equipment and operators. Impact attenuators, sandbags, and other personnel protection measures can be positioned around the unit as required. A suitable location will include a direct line-of-site to one or more areas of interest. Electricity may be provided from local power lines, generators, battery arrays, or from a truck or other vehicle. The system may be self-contained and set-up time is approximately 15 minutes. Training time for an operator is approximately two to four hours. One operator is required for typical operations. Suitable communications may be provided locally to coordinate the system operator with other security personnel.

Once emplaced, the system is ready for operation. The system operator and/or other security personnel can view subjects (i.e., targets) of interest approach, either through channelized approaches or across an open space. The operator uses a video camera (e.g., CCD camera) and a joystick to aim the system at the approaching target(s). A laser rangefinder determines a distance to the target and automatically (or manually) optimizes the focus of the millimeter wave (“MMW”) camera. The joystick controls the pan/tilt stage, which determines the azimuth and elevation data of the target relative to the system. A GPS and altimeter may provide a three dimensional location of the system. Data is fed to the system management and detection software to determine the exact location of the target of interest, the target's motion vector and the threat assessment. That information can then be shared with other sensors to allow for an integrated solution with other technologies or additional MMW systems. The aiming point and target are displayed on the unit's monitor by the integrated CCD video camera. The system scans the target in real time (15 fps) as soon as he/she is in range and automatically processes the scanned image/video for suspicious objects. In addition, the operator views the scanned image/video to confirm the result of the scan. The operator and other security personnel follow local security protocols as required in the event of a possible detection.

In theory, an ideal system would have a range of hundreds of meters which would permit surveillance of targets long before they could approach a secure area. This would increase available security team reaction time to maximal levels. In practice, however, operational range is determined by providing a reasonable degree of early warning time with sufficient space between security personnel and a threat (e.g., suicide bomber) to mitigate blast effects. For example, a system with a 50 m (164′) operating range will provide a safety buffer against lethal air blasts well in excess of 1,000 pounds. This provides a substantial safety zone around much smaller human-carried IEDs and suicide belts. The extended range of 100 m (328′) substantially increases the safety zone.

Object resolution is a key consideration in determining the characteristics of the system. A standard formula for resolution may be used to help select system parameters that will help determine the characteristics of a practical system:

$$R = 1.22 λ ( \frac{D}{d} )$$

where, R is resolution;

λ is wavelength;

D is distance to target; and

d is the entrance pupil diameter for the optics.

This formula when used to calculate the required optical diameter and assuming object resolution at 50 meters of approximately 6.6 cm (2.6″) at 100 GHz, yields an entrance pupil diameter of approximately 2.71 m (9′) wide, which is a wholly impractical size. However, a smaller and operationally acceptable diameter may be achieved at this level of resolution by adjusting the other variables as follows:

1. Decrease wavelength (λ) and/or

2. Select an acceptable size for the entrance pupil diameter (d).

Since wavelength decreases as frequency increases, a desired resolution of 6.6 cm (2.6″) is achieved by raising the operating frequency of the system to 225 to 275 GHz taking into account atmospherics, opacity, clothing transparency, optical design, and availability of necessary components. In this case, 250 GHz at 6.6 cm (2.6″) resolution, and a 50 m distance to target will result in an optical diameter of 1.0 m, which can be integrated into a practical system design for indoor and outdoor use.

All images will be displayed in real-time. Weapons or objects concealed by targets in the surveillance zone will appear as contrasting shades of grey on the millimeter wave display. Automatic detection algorithms isolate the target in question from other subjects outdoors and detect and indicate the concealed objects via computer-generated highlights overlaying graphical user interface (GUI) images. The laser rangefinder scans the field of view to create a range “image” that will allow the software to distinguish between humans, background and objects on the human. A trained operator viewing the MMW image display may also make detections.

Millimeter wave cameras are detection devices that are operative to detect differences or contrast between millimeter wave energy (e.g., electromagnetic wave energy lying in the 225-275 GHz range) that is naturally emitted by the body of an individual and millimeter wave energy that is emitted, reflected, absorbed or otherwise attenuated by any object concealed on that individual. A standard visible spectrum CCD video camera is operative to produce continuous dynamic images on a real-time basis that relate spatially and temporally to the millimeter wave imagery.

The millimeter wave imagery and the visible spectrum imagery may be shown side-by-side on a display having a graphical user interface. Alternatively, the millimeter wave contrast-based imagery may be combined with the images of the individual produced by the visible spectrum CCD video camera to realize a set of composite images. The side-by-side images or composite images show both the individual being scanned and also any concealed object(s) revealed by the contrast-based imagery that was generated in conjunction with the millimeter wave cameras.

Software modules may implement instructions, which interface computer hardware, other software and external devices such as frame buffers, millimeter wave sensor controllers, hard disk drives and the like. Software modules may also be used to control, capture, digitalize and store the imagery from the visible spectrum camera and millimeter wave camera and to evaluate the resultant imagery, stored in a computer memory or other medium, as pixels.

Referring now to FIG. 1, a particular illustrative embodiment of a variable range millimeter wave system is disclosed and generally designated 100. A primary mirror 102 is secured to a front portion of the millimeter wave camera 104 that utilizes Cassegrain style optics to gather and focus millimeter wave energy from a target of interest. The millimeter wave camera 104 is mounted to a tripod head 106 that controls the pan and tilt function. Three tripod legs 108 provide support for the system 100 and may be adjusted for the terrain. A monitor 110 displays the millimeter wave imagery to the operator 112. A corresponding visible spectrum image may be shown on the monitor 110 from a visible spectrum video camera (e.g., CCD camera) to correspond to the millimeter wave imagery. The images may be stored onto a memory device such as hard disk drive. In addition, the images may be encoded with a time stamp indicating the absolute or relative time the image was acquired or references such information by way of a data file or database structure. Each image may also be encoded with other data such as threat presence/absence, threat highlights, sensitivity levels, analysis masks, etc. or this data can be stored into a data file or database structure. A computer-generated visual cue, such as a rectangle, may define an area of a threat that was detected on the image. The system may also integrate imagery from additional dissimilar sources such as x-ray, microwave, infra-red and ultra-violet imagers. Also, the visible spectrum images and millimeter wave images may be displayed as overlays in the same window as a composite image with a user controlled opacity/translucency.

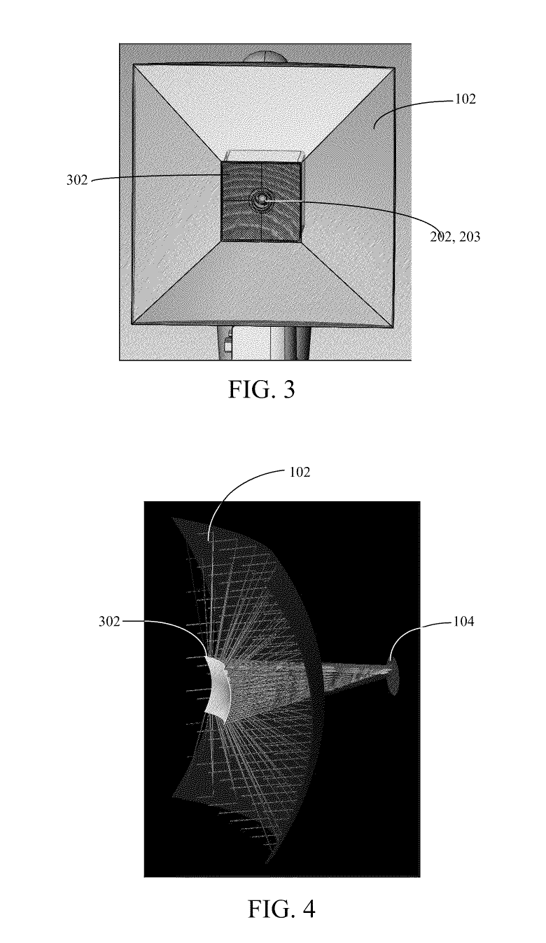

The operator 112 can use the CCD camera 202 and a laser rangefinder 203 mounted at the front of the optics to determine a distance to a target and to adjust the direction of the millimeter wave camera 104 to find the desired target. A global positioning system (GPS) and altimeter of the system 100 provides for a 3-axis (x, y, z) known location of the system. Thus, using the known location of the system 100 from the GPS and altimeter, plus an amount of pan and tilt (azimuth and elevation), and the distance to the target, allows calculation of the precise location of the target. The millimeter wave camera 104 is mounted to a base 204, which is secured to the tripod head 106. The head 106 may have three axes for control including panoramic rotation, front tilt, and lateral tilt. A control handle 206 on the head 106 can be turned to loosen or tighten the certain axes or a joystick may be used to adjust the camera 104 about the axes. The head 106 may use gears for precision control of each axis. The optics include a primary concave mirror 102 and a secondary convex mirror. Both mirrors are aligned about an optical axis, where the primary mirror 102 includes an aperture in the center to permit the millimeter wave energy to reach the millimeter wave detector 104. As best illustrated in FIG. 3, the primary mirror 102 may be generally rectangular in shape and may be collapsed about each quadrant to reduce the size for transport.

Referring now to FIG. 4, the secondary mirror 302 is located in front of the primary mirror 102 so that the primary mirror 102 reflects millimeter wave energy entering the system 100. The secondary mirror then reflects that millimeter wave energy to a focus, which is the millimeter wave detector 104. A variable focus of the optics may be changed from 26 m to 100 m when viewing targets from a distance or to focus the millimeter wave camera to an area of interest.

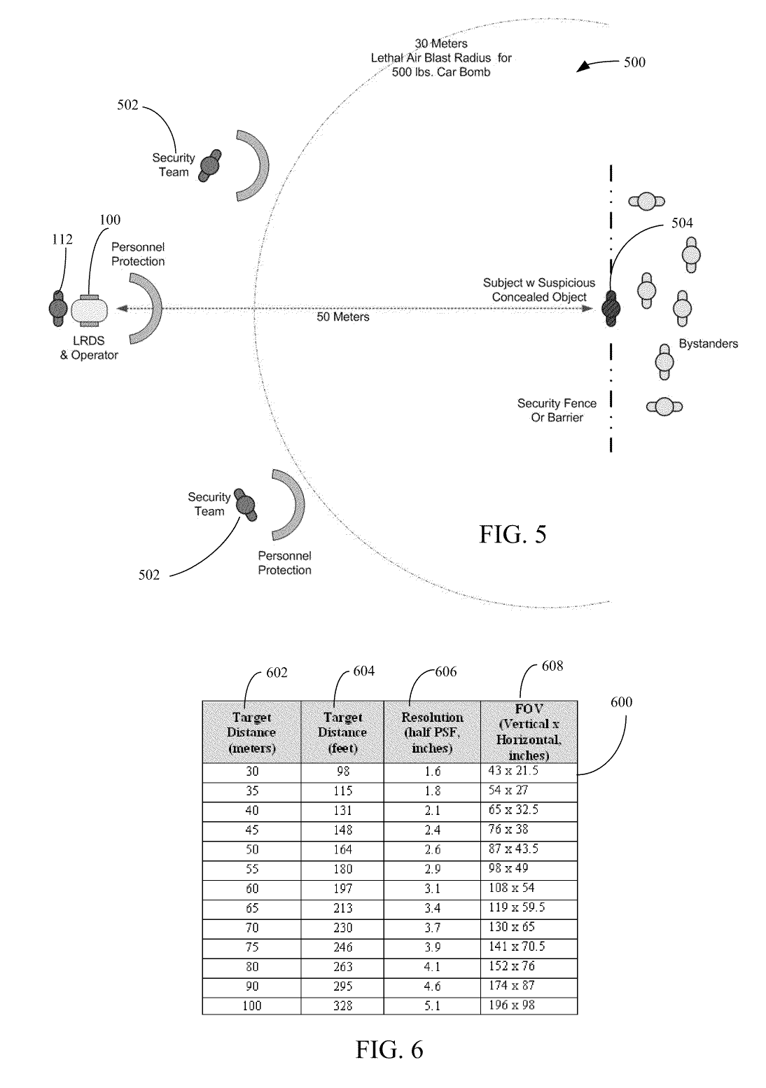

As illustrated in FIG. 5, the operator 112 may be positioned approximately 50 m from a subject 504 with a suspicious concealed object. A 50 m (164′) scanning distance provides security team members 502 with considerably more threat reaction time than current solutions. At an ordinary walking pace of 3 mph, a subject 504 needs about 40 seconds to cover 50 meters. The system operator 112 will need about 3 to 5 seconds to acquire and scan a random subject 504 appearing on a known field of view of 90 degrees arc. For example, if a subject 504 is carrying an IED with a lethal radius of 10 meters and subtract target acquisition and scanning time, then the system operator 112 will be able to alert security team members 502 while the target 504 is still about 30 to 35 meters from the operator 112. Assuming the target 504 is not aware of the detection, the security team will have about 25± seconds to take action before the target reaches the lethal radius near the system (or some other similarly located target.) This is far more reaction time than is currently available using existing scanners.

When viewing subjects distant from the operator 112, or to focus-into an area in question, the variable focus of the optics can be quickly changed via button control, ranging from 26 m to 100 m (85′ to 328′). FIG. 6 identifies the resolution 606 at each distance 602, 604 and field of view (“FOV”). The full-range movement requires approximately 2-3 seconds. Concentrated focus at the middle 50 m (164′) focus setting provides a 6.6 cm×6.6 cm (2.6″×2.6″) sample size for the MMW images. Closer focus settings yield even higher resolutions e.g., 30 m (98′) distance yields a 4.1 cm×4.1 cm (1.6″×1.6″) sample size. The system frame rate is 15 fps for imaging and automated concealed object detection (when possible) combined.

A means is provided for electrically communicating image signals between the CCD video camera, millimeter wave camera, and a central processing unit device which receives and processes such signals. The millimeter wave images are synchronized with the video images to a substantially identical time base so that real-time composite images of the millimeter wave images and video images may be generated. The central processing unit device includes at least one processor and a memory that is accessible to the processor. The processor controls subsequent analysis and dynamic processing of millimeter wave imagery. The memory includes media that is readable by the processor and stores data and program instructions of software modules that are executable by the processor, including a scanning software module for controlling the millimeter wave camera 104 and the CCD camera 202. In a particular embodiment, a graphical user interface is coupled to the system 100 may include a keyboard, a pointing device, a touch screen, a speech interface, another device to receive user input, or any combination thereof.

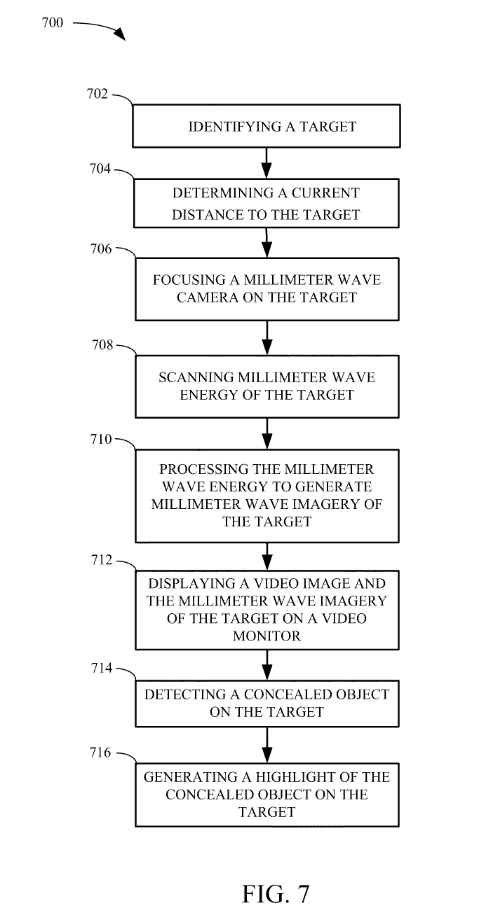

Referring now to FIG. 7, a particular illustrative embodiment of a variable range millimeter wave method is disclosed and generally designated 700. A target is identified, at 702. A current distance to the target is determined, at 704, where the distance may be determined using a laser rangefinder. Moving to 706, a millimeter wave camera is focused on the target and the millimeter wave energy of the target is scanned, at 708. The millimeter wave energy is received using pixels, wherein the pixels correspond to a spatial position on the target at a current time frame. The millimeter wave energy is processed, at 710, to generate millimeter wave imagery of the target. The millimeter wave imagery is generated using calculated values that represent an amount of millimeter wave energy associated with at least one respective pixel. Algorithms may be used to resolve the pixels, recognizing contrast cells based on differences in millimeter wave energy. In addition, algorithms may be used for detecting and recognizing the presence of the target and to discern the target's range and direction of motion relative to the millimeter wave camera. Algorithms may also be used to evaluate the results of the target's range and motion and intelligently direct or change the subsequent detection methodology based on the analysis. A video image and the millimeter wave imagery are displayed on a video monitor, at 712, which may indicate detection of a concealed object on the target, at 714. Continuing to 716, the concealed object on the target may be highlighted on the video image, millimeter wave imagery, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A variable range millimeter wave system, the system comprising:
a primary mirror to reflect millimeter wave energy to a secondary mirror;
the secondary mirror disposed in front of the primary mirror and adapted to redirect the millimeter wave energy to a millimeter wave detector of a millimeter wave camera; and
the millimeter wave camera configured to process the millimeter wave energy to visually detect concealed objects hidden on a target.

2. The variable range millimeter wave system of claim 1, wherein an operating frequency of the millimeter wave camera is between 225 GHz and 275 GHz.

3. The variable range millimeter wave system of claim 2, further comprising a laser rangefinder to determine a distance to the target and to optimize a focus of the millimeter wave camera.

4. The variable range millimeter wave system of claim 3, further comprising a global positioning system (GPS) and altimeter.

5. The variable range millimeter wave system of claim 4, further comprising a video monitor to display millimeter wave imagery generated from the millimeter wave energy.

6. The variable range millimeter wave system of claim 5, further comprising at least one visible spectrum video camera to generate video images spatially and temporally relative to the millimeter wave imagery and to aid targeting.

7. The variable range millimeter wave system of claim 6, further comprising a tripod to rotate, front tilt and lateral tilt the primary mirror and secondary mirror.

8. The variable range millimeter wave system of claim 7, wherein the primary mirror is configured to collapse for transport and storage.

9. The variable range millimeter wave system of claim 8, further comprising a graphical user interface (GUI) to manage the displayed millimeter wave imagery.

10. The variable range millimeter wave system of claim 9, further comprising a memory device for storing the millimeter wave imagery.

11. The variable range millimeter wave system of claim 10, further comprising at least one battery to power the system.

12. A variable range millimeter wave method, the method comprising:
identifying a target;
determining a current distance to the target;
focusing a millimeter wave camera on the target;
scanning millimeter wave energy of the target;
processing the millimeter wave energy to generate millimeter wave imagery of the target; and
displaying a video image and the millimeter wave imagery of the target on a video monitor.

13. The variable range millimeter wave method of claim 12, further comprising isolating the millimeter wave energy of the target from other persons and objects in a scene.

14. The variable range millimeter wave method of claim 13, further comprising detecting a concealed object on the target.

15. The variable range millimeter wave method of claim 14, further comprising generating a highlight of the concealed object on the target.

16. The variable range millimeter wave method of claim 15, further comprising reflecting the millimeter wave energy of the target from a primary mirror to a secondary mirror and from the secondary mirror to the millimeter wave camera.

17. The variable range millimeter wave method of claim 16, wherein an operating frequency of the millimeter wave camera is between 225 GHz and 275 GHz.

18. The variable range millimeter wave method of claim 17, wherein the current distance to the target is between 30 m and 75 m.

19. The variable range millimeter wave method of claim 18, wherein a resolution of the millimeter wave energy is between approximately 4.1² cm² and 13.0² cm².

20. The variable range millimeter wave method of claim 19, wherein an optical diameter of the primary mirror is approximately 1.0 m.
